(19) United States
(12) Patent Application Publication
(10) Pub. No.: US 2013/0294355 A1
(43) Pub. Date: Nov. 7, 2013

(54) Method and Architecture of System for Opening Channels on Establishment of VoIP Communication in p BGAN, SwiftBroadband and FleetBroadband Clear Mode

(71) Applicants: Dominique Billonneau, Gennevilliers (FR); Nicolas Suard, Gennevilliers (FR)

(72) Inventors: Dominique Billonneau, Gennevilliers (FR); Nicolas Suard, Gennevilliers (FR)

(73) Assignee: THALES, Neuilly-sur-Seine (FR)

(21) Appl. No.: 13/814,932

(22) PCT Filed: Aug. 9, 2011
(86) PCT No.: PCT/EP11/63664

§ 371 Date: Apr. 30, 2013

(30) Foreign Application Priority Data
Aug. 10, 2010 (FR) 10 03334

(51) Int. Cl. H04W 72/08

(52) U.S. Cl. CPC H04W 72/08
USPC 370/329

(57) ABSTRACT

A system architecture makes it possible to dynamically open communication channels of optimized dimension with guaranteed bit rate, the communication protocol used being the RTP protocol, said system architecture being intended to be positioned in an aircraft, a ship and/or a suitcase, and/or a ground station comprising one or more voice-over-IP terminals, said architecture comprising at least the following elements: a ground or onboard SIP server comprising at least the following elements: a bit rate adapter module which controls, paces, adapts the bit rate of the RTP stream received by a terminal, a module for controlling the signaling included in the data streams, said control module comprising a signaling interception module, a signaling modification module, said signaling interception module receiving the information from a terminal transmitting data and an access control module.

The invention relates to a method and a system architecture making it possible to dynamically open communication channels of optimized dimensions with guaranteed bit rate, of Inmarsat for example. The architecture is, for example, implemented for the opening of channels on the setting up of voice-over-IP (VoIP) communication in BGAN clear mode (an IP and voice service delivered simultaneously at high bit rate through the Inmarsat 3G network), for services known by the names “SwiftBroadband” and “FleetBroadband” (Inmarsat maritime communication services).

The system architecture for example takes the form of an embedded platform which can be onboard an aircraft, a ship, a vehicle, or in a suitcase, and a ground platform which is interfaced with the public or private networks. The embedded platform serves a network using internet protocol IP to which are connected computer equipment items (data, voice or speech, video, etc.).

### DEFINITIONS

Hereinafter in the description, the following abbreviations and their definitions will be used:

PDP: Packet Data Protocol, a PDP context comes from the GPRS technology known to the person skilled in the art; it is a set of information which characterizes a basic transmission service; it combines parameters which enable a subscriber to communicate with a well defined PDP address, following a determined quality of service profile (delay, priority, bit rate, etc.).

RTP: Real Time Protocol. Protocol over IP which makes it possible to identify the type of information transported, to add markers, sequence numbers and to monitor the arrival of the packets at the destination.

TFT: Initials which designate a series of filters which ensures a determined path for applications for which the stream is identified by the TFT, Traffic Flow Template filters. For example, the Inmarsat technology uses TFTs.

VoIP: voice over IP.

SIP: Service initialization protocol or Session Initiation Protocol. This protocol is normalized and standardized. It handles the authentication and the location of the multiple participants. It also handles the negotiation on all the types of media that can be used by the different participants by encapsulating SDP (Session Description Protocol) messages. SIP does not transport the data exchanged during the session such as voice or video. Since SIP is independent of the transmission of the data, any type of data or of protocols can be used for this exchange. However, the RTP protocol more often than not handles the audio and video sessions.

The word “streaming” denotes a class of Satcom services guaranteeing a guaranteed bit rate (used mainly for the real-time applications).

The word “transceiver” is used to designate a transceiver, the particular function of which is to broadcast one input signal to a plurality of outputs.

The expression “onboard” corresponds to the equipment items arranged onboard a satellite or an aircraft and the expression “ground” corresponds to the equipment items situated in a ground station.

The expression “external route” concerns the routing mechanisms implemented by the SIP function of the “redirect Proxy”. It concerns the redirecting of the calls not found locally to another proxy via the defined route.

The expression “inbound call” corresponds to an incoming call, in contrast to the expression “outbound call” corresponding to an outgoing call.

In the telecommunication satellites that notably use a satellite, two types of service category are generally proposed:
a “Best Effort” type service where the user pays by the megabyte consumed, but there is no guarantee of quality of service. That is to say that, if there are a lot of simultaneous uses on the satellite link, the quality is greatly degraded. For telephony over IP services (Internet Protocol) or for video conferencing, this prohibitive.
a streaming type service for which the user pays for the connection time (very high price), but which has, conversely, a guarantee of service which enables it to ensure real-time services, such as voice or video or even a priority link of the satellite resource.

### Onboard-Ground Mechanism

In the state of the art, the setting up of a communication between a ground platform and a system embedded on an aircraft or on a satellite requiring a quality of service is performed by the prior opening of a 32 K or 64 K or 128 K streaming channel that does not prejudice the real volume of the band used and consumes the resource from the time of opening.

The “streaming” (reading in continuous stream mode) channel is opened, with payment from the time of opening, in order to allow for the signaling to pass. If the recipient of the call does not answer, the communication is billed up to the point of the releasing of the channel.

Furthermore, the absence of time management of the vocoders in the communication equipment items and the absence of optimization of the rate adjustment in the transmission of voice-over-IP packets make it possible to make only calls that use on average 80 Kbps (G.711 type vocoder) of bandwidth per communication.

Nevertheless, certain architectures offer the possibility of concatenating a plurality of communications in a previously activated “streaming”channel without control of the vocoder and of the rate adjustment (number of frames in a “payload” or data routed). This mechanism can prove of interest if the open channel is always busy with a significant volume of communications, otherwise a channel is open with insufficient traffic and its operating cost can be very high.

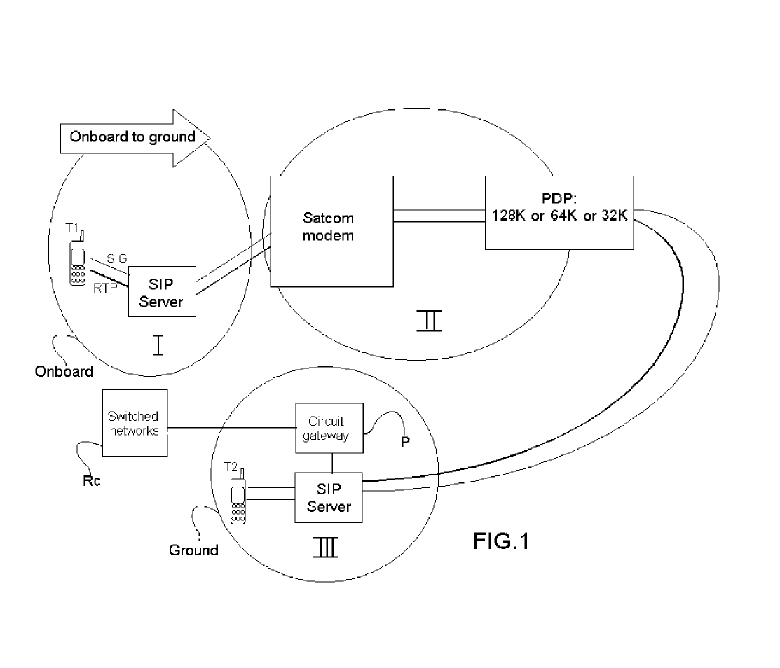

The mechanism is illustrated in FIG. 1 which illustrates exchanges of communications transmitted by a first terminal T₁ positioned on an aircraft or satellite or “onboard” to the ground via a first SIP server situated onboard an aircraft I, a Satcom II link or module transmitting the data by using the PDP protocol, a second SIP server situated in a ground station III linked to a terminal T₂, a circuit gateway P, a switched telephony network Rc.

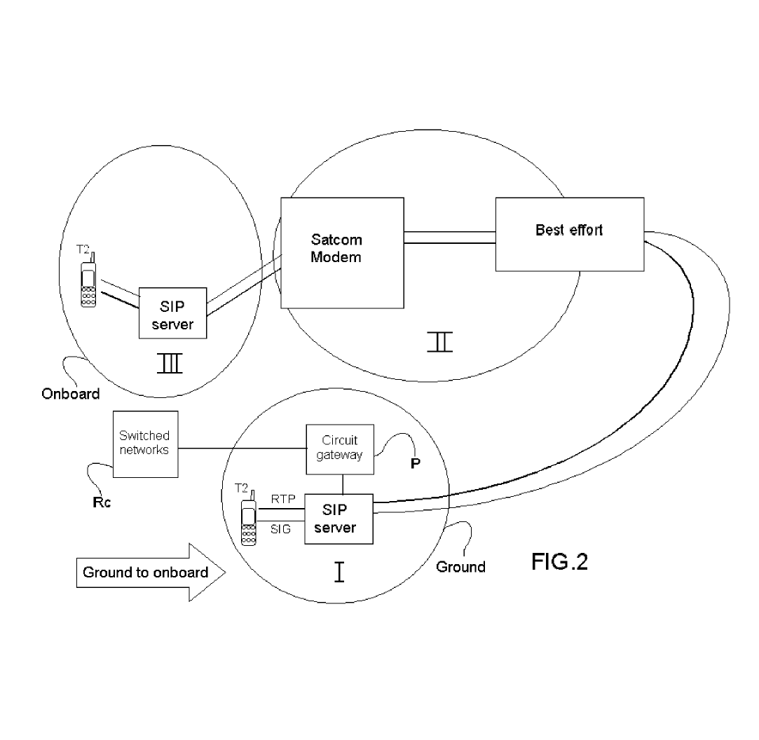

FIG. 2 schematically represents the data exchanges during a communication set up in the reverse direction to that described in FIG. 1, namely from ground to onboard between a terminal T₁ and a terminal T₂.

In the state of the art, a communication set up from the ground is systematically carried out in the Best Effort mode. If a streaming quality communication is required from the ground, the channel must first be opened from the airplane.

The object of the invention relates to a system architecture making it possible to dynamically open communication channels of optimized dimension with guaranteed bit rate, the communication protocol used being the RTP protocol, said system architecture being intended to be positioned in an aircraft, a suitcase and/or a ship, and/or a ground station comprising one or more voice-over-IP terminals, said architecture comprising at least the following elements:
a ground or onboard SIP server comprising at least the following elements:
a bit rate adapter module situated between at least one transmitting terminal T₁ and one receiving terminal T₂, said bit rate adapter module (5) being a software function borne by the SIP server which controls, paces, adapts the bit rate of the RTP stream received by a terminal,
a module for controlling the signaling included in the data streams, said control module comprising a signaling interception module, a signaling modification module, said signaling intersection module receiving the information from a terminal transmitting data and an access control module.
The data terminal is, for example, a voice-over-IP terminal transmitting data D in parallel with the speech data to a routing module which communicates with the speech IP terminal.

The routing module applies, for example, the TFT rules, the communication system being a satellite system (BGAN, SwiftBroadband and FleetBroadband or GPRS).

The bit rate adapter module can be a module allowing for an adaptation of a G.729 low bit rate codec to the G.711 codec and vice versa.

The invention also relates to a method allowing for a dynamic opening of communication channels in a communication system using the RTP protocol, between at least two speech terminals, said method being implemented in the abovementioned architecture, said method being characterized in that it uses a virtual terminal mechanism implemented in an application using the services of an SIP server and in that it comprises at least the following steps:
1) intercepting the “INVITE” message by means of an SIP server, transmitted in the data stream,
2) determining the coder-decoder used in a speech terminal T₁, T₂,
3) if the coder is a low bit rate coder, then allowing the communication to pass without modifying the data,
4) otherwise, converting the calls transmitted at high bit rate into low bit rate at the time of the call request by identifying the codecs requested by the terminals as soon as the real media streams received by one of the terminals are set up.

According to one embodiment of the method, the communication system uses a voice-over-IP data terminal transmitting data D in parallel with the speech data to a routing module which communicates with the speech IP terminal.

The method can implement a routing module applying the TFT rules, the communication system being a satellite system of BGAN, SwiftBroadband and FleetBroadband or GPRS type.

The method can use a bit rate adapter allowing for an adaptation of the G.729 codec to the G.711 codec and vice versa.

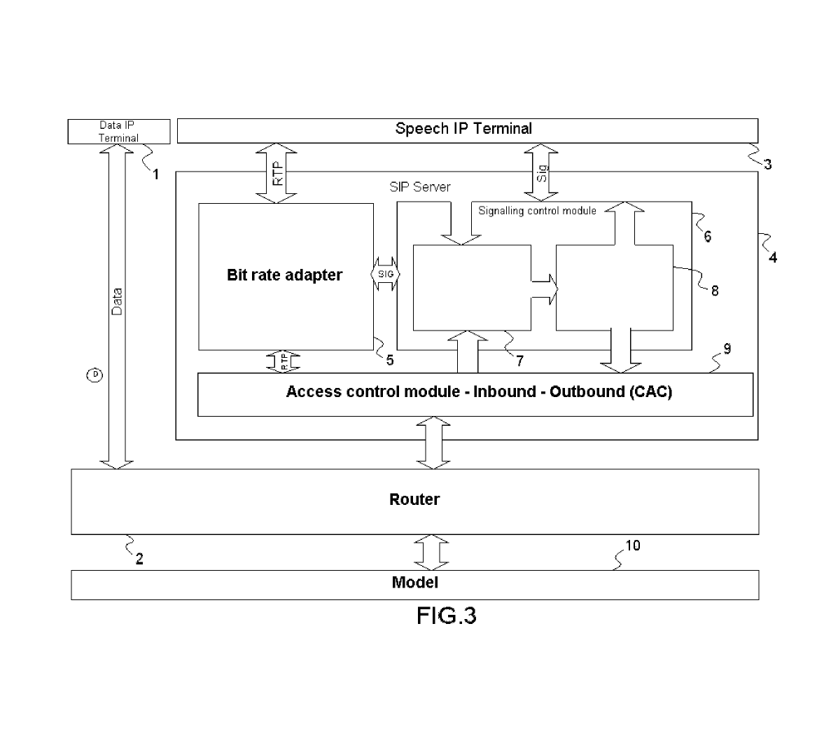

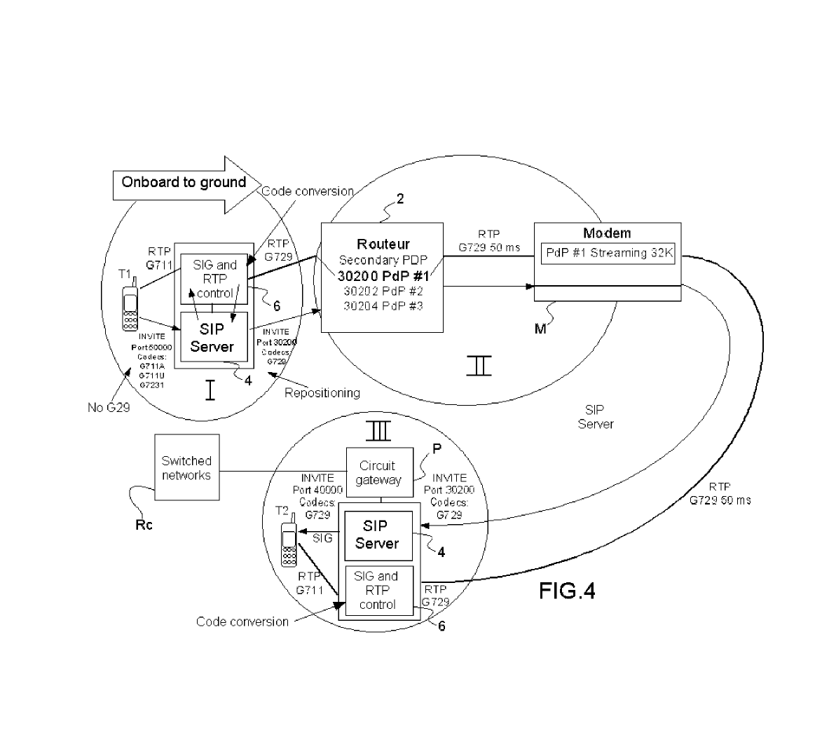

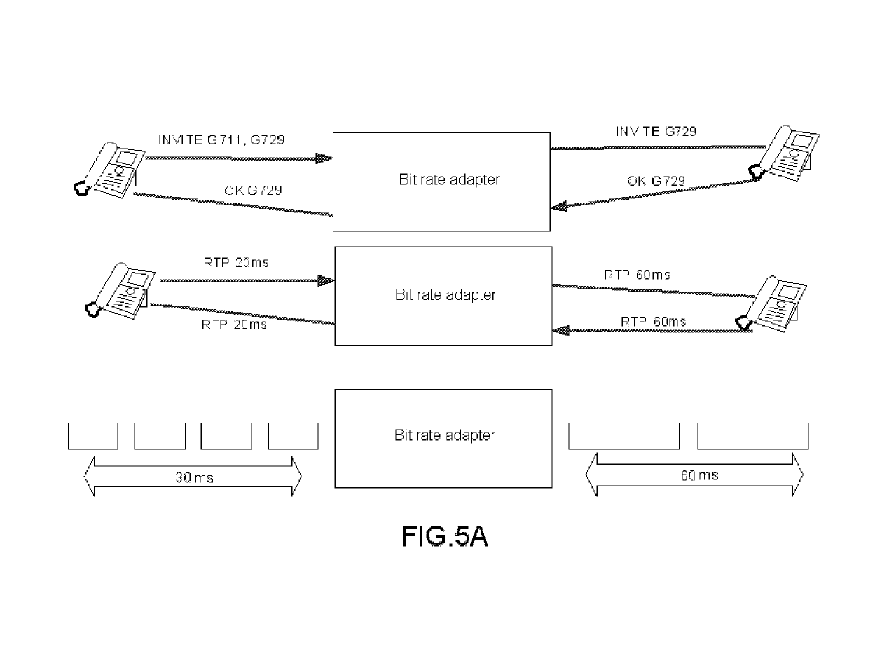

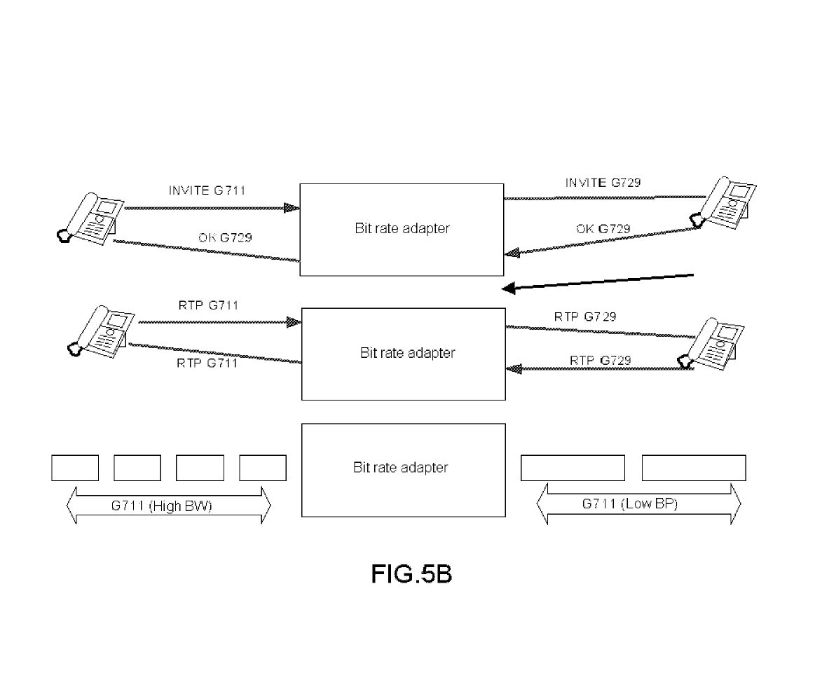

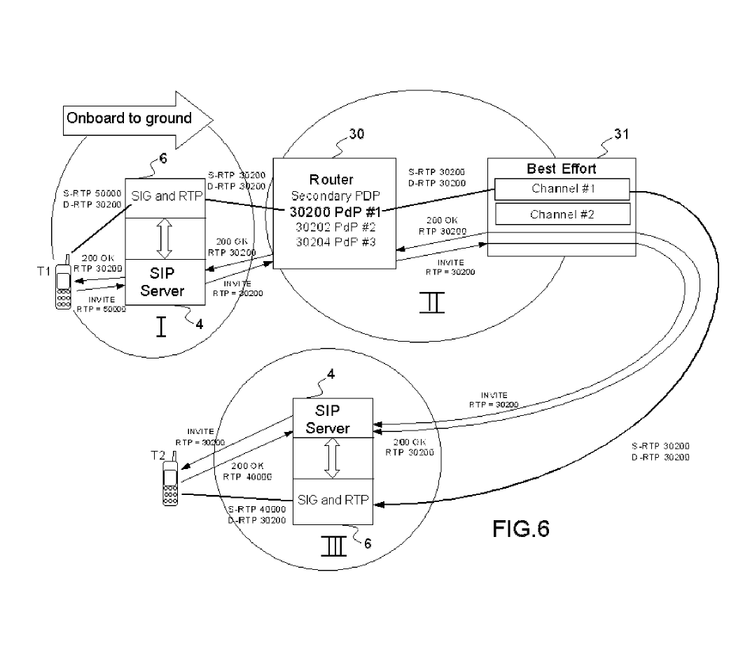

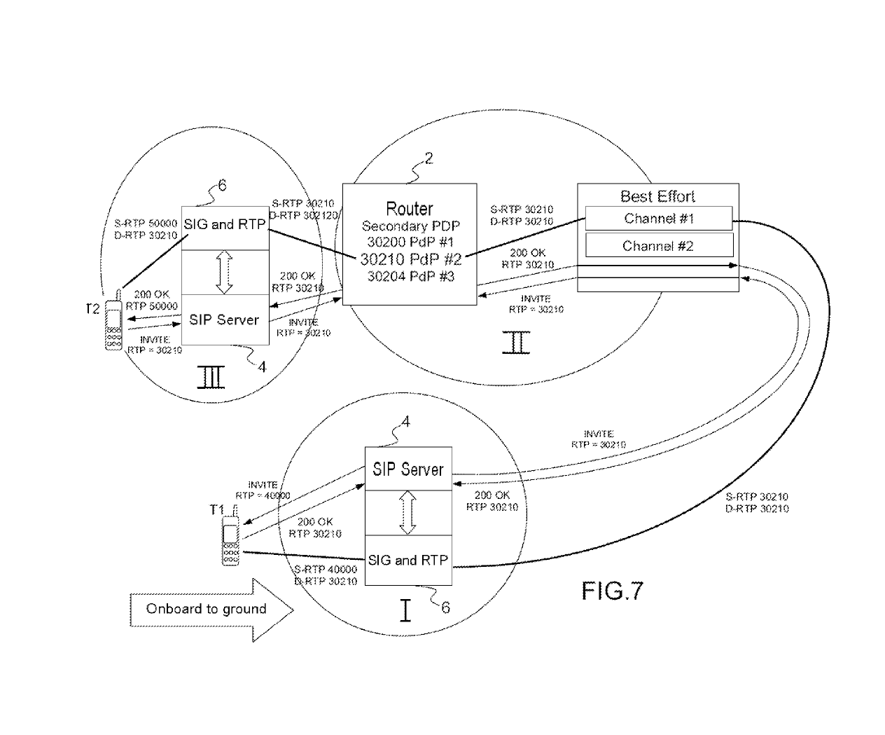

Other features and advantages of the device according to the invention will become more apparent on reading the following description of an exemplary embodiment given as an illustration and in no way limiting with figures appended which represent:
FIG. 1, a representation of the state of the art of a mechanism for transmitting data from onboard to the ground,
FIG. 2, a representation of the state of the art of a mechanism for transmitting data from the ground to onboard,
FIG. 3, an exemplary architecture that makes it possible to implement the method according to the present patent application,
FIG. 4, an example of transparent code conversion
FIG. 5A, an example of steps implemented for the elimination of the high bit rate vocoders and the readjustment of the rate of the voice-over-IP packets, and FIG. 5B, an example of steps implemented for the code conversion of the voice-over-IP packets,
FIG. 6, an illustration of the succession of steps for setting up an outbound VoIP call, and
FIG. 7, an illustration of the succession of steps for setting up an inbound VoIP call.

In order to better understand the method and the architecture according to the invention, the following description is based on the use of the SIP standard protocol. The mechanisms implemented are therefore transparent to any terminal compatible with the protocol. The method and the architecture according to the invention notably use virtual terminal mechanisms implemented in an application which uses the services of the IP server.

FIG. 3 represents exemplary architecture of the system according to the invention, comprising an IP data terminal 1, which transmits data D to a routing module or router 2, and a speech terminal 3 which communicates in parallel with an SIP server 4 for the signaling and the RTP stream. Such an architecture can be arranged both in so-called “onboard” equipment items of a vehicle, ship or aircraft, and in ground equipment items or stations.

The SIP server 4 comprises a bit rate adapter module 5 which controls, converts, adapts and readjusts the bit rate of the RTP protocol, a signaling control module 6, itself comprising a signaling interception module 7 and a signaling modification module 8.

The signaling interception module 7 receives information from the IP terminal but also from the access control module 9.

The signaling modification module will transmit the modified signaling information on the one hand to the IP terminal, on the other hand to the access control module 9 and to the bit rate adapter module 5.

The router 2 exchanges data with the access control module 9 and with the Satcom Modem 10 or any other modem implemented for a communication between a ground station and any aircraft or satellite.

The IP terminal in this figure represents, for example, the onboard telephony terminal, T₁ in FIG. 1.

The function of the routing module 2 is notably to route different data streams over the good Satcom resources, that is to say the primary context PDP or PDPs containing the secondary PDPs associated with the TFT rules by applying the TFT rules.

The signaling control module 6, SIG, is a function which analyses the SIP signaling present in a data packet or in a data stream, in order to control and modify the RTP port numbers and the coders-decoders or codec implemented by the terminals T₁, T₂. It drives the bit rate adapter module 5. The codecs are not represented in the figures for reasons of simplification.

The architecture described in FIG. 3 applies both for ground segments and for onboard segments. The references ′ will be used to differentiate the elements of the onboard segment from those of the ground segment.

The Satcom resource management rules require, from the point of view of the routing module, the RTP ports used by the telephone communications to correspond to the TFT rules.

Automatically managing the traffic presents a number of problems:
The application of the TFT rule has to be done based on the knowledge of the ports before the setting up of the communication between two terminals.
The knowledge of the ports is possible only on setting up the communication.
The assignment of the ports is dynamic.

The signaling control module 6 and bit rate adapter module 5 make it possible to perform a port translation for the call (INVITE) and call acceptance (200 OK) messages passing through them. This makes it possible to mark the combinatorial aspect of the port numbers of the different SIP handsets used in the network and to use only a small number of RTP ports (one port number per Outbound and Inbound voice communications).

Physically, the signaling control module 6 analyzes the signaling for a given communication, or data stream to be transmitted, to know the RTP port number announced in the call packet (INVITE) from the transmitting terminal T₁ and by the receiving terminal T₂ in the response (200 OK). This number is specific to each terminal and cannot be configured.

To remedy this technical problem, the method and the architecture according to the invention use virtual terminal mechanisms implemented in an application which uses the services of the IP server. It is through these virtual terminals that it will be possible to adapt a dynamic and uncontrolled allocation to the TFT static rules.

On reception of a call, the SIP server (onboard or ground, depending on the direction of the call) supplies a free RTP port number (defined by configuration), then opens the call packet and replaces the port number requested by the terminal T₁ with that which has just been assigned. The call packet is then transmitted to the external route with a new port number.

### Adaptation of the Consumed Bandwidth

In the SIP protocol, the terminals can negotiate with one another for the best possible codec.

In the example given, the chosen vocoder is G.729, so as to be sure that a communication takes place in a 32 Kbit/s streaming channel.

Another function of the signaling control module is to remove the high bit rate vocoders, i.e. in the context of the example, those with a bit rate greater than 32 Kbit/s (IP+UDP+RTP+payload), from the call message.

In fact, as is illustrated in FIG. 4 representing a communication from an embedded station to a ground station, a low bit rate codec will be chosen if it is present in the ground equipment item and in the embedded equipment item.

In the case where a low bit rate codec is present from end to end in the communication system, if an “INVITE” message at the start of an external route (signal transmitted by the terminal T₁) has a low bit rate vocoder, then the method will not have to convert or more generally modify the data stream.

In the case where a low bit rate codec is not present in the equipment items, the method and the architecture according to the invention will use the 64 Kbits/s G.711 codec present in all the terminals, and carry out a conversion to a low bit rate codec. It is the bit rate adapter module 5 which is responsible for this conversion as is illustrated in FIG. 5B.

The steps implemented by the method in this case are, for example, as follows: in the case where the system architecture at the ground level and at the onboard level has no low bit rate vocoder,

If an “INVITE” message at the start of an external route does not have any low bit rate vocoder,

### Outbound Call (FIGS. 3 and 4)

The onboard SIP server 4 accepts the calls in G.711 mode for example, and converts them to G.729. It is the bit rate adapter module 5 which is responsible for this code conversion.

The ground SIP server performs a reverse operation by accepting the calls in G.729 mode via the signaling and RTP control module and converting to G.711 to the called terminal T₂. The converted communication stream is then transmitted via the circuit gateway P, then via switching networks Rc.

### Inbound Call

The ground SIP server accepts the calls in G.711 mode and converts them to G.729. The code conversion is performed by virtue of the bit rate adapter module situated in the ground equipment item.

The onboard SIP server accepts the calls in G.729 mode and converts them to G.711 to the called terminal. The code conversion is performed by virtue of the bit rate adapter module situated in the onboard equipment item.

### Bit Rate Adapter Module, 5

The role of this bit rate adapter module is to be placed inline on the RTP streams to readjust the rate of the streams and perform a code conversion if necessary. This means that the module is situated between the two terminals T₁ and T₂ in the example given.

By readjusting the rate of the streams, it notably becomes possible to obtain an excellent voice quality for a real minimum bandwidth of less than 32 Kbits per second.

This bit rate adapter module 5, as has been described previously, is also responsible for converting packets transmitted in high bit rate codec mode by the terminals to low bit rate voice packet mode for transmission over a satellite connection (local area network and ground network).

The bit rate adapter is an intelligent software function borne by the SIP sever.

The bit rate adapter makes it possible to reduce the VoIP bit rate in an intelligent manner in order to allow for the use of low bit rate links by optimizing:
the maximum bit rate on the links used
the voice quality
the CPU used for the operations

The bit rate adapter works in two steps schematically represented in FIGS. 5A, 5B:

1. from the call request transmitted by a terminal by identifying the codecs requested by the terminals, and by proposing or eliminating some,

2. from setting up of the real media streams received by the terminals. It is also designed to work in both onboard-ground and ground-onboard communication directions.

These two steps finally make it possible to work according to two modes:

1. The rate readjustment of voice packets suited to the low and medium compression commands schematically represented in FIG. 5A. In this example, it can be seen that the frame of voice-over-IP packets is readjusted from 30 ms to 60 ms.

2. The code conversion of packets suited to the strong compression demands schematically represented in FIG. 5B, for example by switching from a coding bit rate of G.711 type, high bit rate coding, to low bit rate coding of G.729 type. Obviously the G.711 and G.729 coding types are given solely as an illustration and are in no way limiting.

The work on the signaling relates to the forcing, if possible, of the terminals to use the same low bit rate codec (<=32 Kbits typically).
In the case where one of the terminals can not support such a codec, this is detected in this first phase and the code conversion will be applied.

### Outbound Call

FIG. 6 schematically represents the setting up of an outbound VoIP call over an end-to-end segment. This figure particularly shows the processing operation linked to the exchange, by the two telephones or terminals, in this example, calling T₁ and called T₂, of the initial “INVITE” and “200 OK” messages.

Whether the call is identified as outbound or inbound, the SIP servers have to take the place of the terminals T₁, T₂ and spoof them in order to be able to modify their RTP ports.

An example of the chronology the steps implemented in the case of an outbound call is given herein below.

### ONBOARD

### Example

The transmitting terminal T₁ presents the call to the onboard SIP server with:

Port RTP 50000

The onboard SIP server captures the INVITE message.

The call is for an external route.

Check by the access control module on the number of inbound and outbound calls on this route.

Check for the presence of the low bit rate vocoder (e.g.: G.729) in the INVITE message.

The SIP server transmits a “200 trying” message to the terminal requesting the call T₁.

The onboard SIP server requests an external RTP port number.

The first free external port number is assigned.

The onboard SIP server continues the call to the router.

The call is continued in the “best effort” mode, 30, 31, that is to say that the call is transmitted to the GROUND equipment items by using the “best effort” mode 31 via a routing module 30.

### GROUND

The SIP ground server 4′ receives an INVITE message over its external route (trunk linking the onboard SIP server and the ground SIP server).

Marking of a call on this route as inbound, marking of the call which is performed by the access control module.

Continuation of the call by recovery of the IP address derived from the call number and contained in the registration base (REGISTRAR) of the terminals connected to the SIP server from the ground to the called terminal T₂.

The called terminal responds with a 200 OK with the port that it wants to use for the RTP (40000).

The ground SIP server captures the call acceptance message (200 OK).

The ground SIP server requests an external RTP port number.

The first free external port is assigned (30200); the ground server continues the call to the GROUND router.

### ONBOARD

The onboard SIP server receives the 200 OK and continues the call to the terminal T₁ without modifying the confirmation message (200 OK).

The calling terminal T₁ transmits the RTP frames with 50000 as source port and 30200 as destination port.

The bit rate adapter module 5 is connected inline, that is to say between the terminals T₁ and T₂.

Reception of the frames and modification of the source port to 30200.

The frames are sent to the routing module according to the invention with 30200 as source port and 30200 as destination port.

The uplink and downlink traffic is now assigned to an RTP port that is controlled and known in the TFT rules. The traffic is now assigned automatically to a streaming channel through a perfect correspondence with the TFT rules.

### Inbound Call

To avoid the assignment of identical ground and onboard ports, the method makes it possible to assign them automatically and by configuration in descending order from onboard to ground and in ascending order from ground to onboard.

A port range is defined (by configuration) in the onboard SIP server and in the ground SIP server. Its range begins, for example:
Port 30200 to 30250 with an assignment of 30200 to 30250 from the onboard
Port 30200 to 30250 with an assignment of 30250 to 30200 from the ground.

If a call is initialized from the onboard, the onboard SIP server assigns the port 30200 if it is free in the call packet.

If a call is initialized from the ground, the ground SIP server assigns the port 30250 if it is free in the call packet.

This mechanism of assignment in ascending order (from the onboard) and descending order (from the ground) is repeated until all the ports are busy.

A port released (communication hung up) is reassigned if another communication is initialized.

The invention is transparent for the calls originating from the GROUND. These are performed in the Best Effort mode (for the signaling) with changing of the ports on the GROUND to satisfy or observe the TFT rules of the aircraft or of the airplane.

The chronology of the steps can be as follows: according to FIG. 7:

### GROUND

The calling terminal T₁ transmits a call with 40000 as RTP port number

RTP port 40000

Codec G.711A, G.711U, G.729, G.723.1

The ground SIP server 4 captures the INVITE message

The call is for an external route

Check on the number of inbound and outbound calls on this route by the access control module,

If a call is possible, marking of a call as outbound

Check for the presence of the low bit rate vocoder (example: G.729) in the INVITE message

The ground SIP server transmits a “trying” to the terminal T₁ requesting the call

The ground SIP server requests an external RTP port number

The first free external port is assigned (30210)

The ground SIP server continues the call

The call is continued in the Best Effort mode

### ONBOARD

The onboard SIP server 4′ receives an invite message on its external route

Marking of a call on this route as inbound

Continuation of the call to the called terminal

The called terminal T₂ responds with a 200 OK with the port that it wants to use for the RPT (50000)

The onboard SIP server 4′ captures the INVITE message

The onboard SIP server 4′ modifies the RTP port to 30210.

### GROUND

On reception of the 200 OK, the terminal T₁ transmits the RTP frames to the recipient T2 in the Best Effort mode.

### ONBOARD

On reception of the frames at 30210, the routing module situated in the onboard system assigns the call automatically to a defined streaming channel.

The method and the system architecture according to the invention therefore make it possible:

To generate the signaling in the Best Effort mode,

To generate the voice in the streaming,

To open an optimized streaming channel for each communication automatically for a call leaving the system, better known as “outbound”, or a call entering into the system, or “inbound”.

To force the terminals to negotiate in G.729 (coding of the speech at 8 Kbit/s by linear prediction with excitation by coded sequences with conjugate algebraic structure) or another low bit rate codec if this vocoder is present,

To convert to low bit rate if the vocoder is not present in the terminals,

To optimize the rate adjustment of the voice frames,

To guarantee that the number of communications (incoming and outgoing) authorized by the bandwidth will not be exceeded,

Compatability with the SIP standard.

They also offer the possibility of adapting to strong bandwidth constraints. The constraint is to guarantee that a communication will always take place in a channel of smallest possible size, this size being fixed regardless of the terminals used.

1. A system architecture making it possible to dynamically open communication channels of optimized dimension with guaranteed bit rate, the communication protocol used being the RTP protocol, said system architecture being intended to be positioned in an aircraft, a suitcase and/or a ship, and/or a ground station comprising one or more voice-over-IP terminals Ti, said architecture comprising at least the following elements:
a ground or onboard SIP server (4) comprising at least the following elements:
a bit rate adapter module situated between at least one transmitting terminal T₁ and one receiving terminal T₂, said bit rate adapter module being a software function borne by the SIP server which controls, paces, adapts the bit rate of the RTP stream received by a terminal,
a module for controlling the signaling included in the data streams, said control module comprising a signaling intersection module, a signaling modification module, said signaling interception module receiving the information from a terminal transmitting data and an access control module.

2. The architecture as claimed in claim 1, wherein the data terminal is a voice-over-IP terminal transmitting data D in parallel with the speech data to a routing module which communicates with the speech IP terminal.

3. The architecture as claimed in claim 1, wherein the routing module applies the TFT rules, the communication system being a satellite system of BGAN, SwiftBroadband and FleetBroadband or GPRS type.

4. The architecture as claimed in claim 1, wherein the bit rate adapter module is a module allowing for an adaptation of a G.729 low bit rate codec to the G.711 codec and vice versa.

5. A method allowing for a dynamic opening of communication channels in a communication system using the RTP protocol, between at least two speech terminals, said method being implemented in the architecture as claimed in claim 1, said method using a virtual terminal mechanism implemented in an application using the services of an SIP server and comprising at least the following steps:
intercepting the “INVITE” message by means of the SIP server, transmitted in the data stream,
determining the coder-decoder used in a speech terminal T₁, T₂,
if the coder is a low bit rate coder, then allowing the communication to pass without modifying the data,
otherwise, converting the calls transmitted at high bit rate into low bit rate at the time of the call request by identifying the codecs requested by the terminals as soon as the real media streams received by one of the terminals are set up.

6. The method as claimed in claim 5, wherein the communication system uses a voice-over-IP data terminal transmitting data D in parallel with the speech data to a routing module which communicates with the speech IP terminal.

7. The method as claimed in claim 5, implementing a routing module applying the TFT rules, the communication system being a satellite system of BGAN, SwiftBroadband and FleetBroadband or GPRS type.

8. The method as claimed in claim 5, using a bit rate adapter module allowing for an adaptation of the G.729 codec to the G.711 codec and vice versa.
